(19) United States
(12) Patent Application Publication
(10) Pub. No.: US 2008/0041124 A1
(43) Pub. Date: Feb. 21, 2008

(54) STEEL BAR AND PADLOCK FOR A SHIPPING CONTAINER

(76) Inventor: ARTURO VALDES RUDD, GYE (EC)

Correspondence Address: DANIEL S. POLLEY, P.A., 1215 EAST BROWARD BOULEVARD, FORT LAUDERDALE, FL, 33301, US

(21) Appl. No.: 11/828,021

(22) Filed: Jul. 25, 2007

Related U.S. Application Data
(60) Provisional application No. 60/820,439, filed on Jul. 26, 2006.

(51) Int. Cl. B65D 55/02; E05B 67/00

(52) U.S. Cl. 70/20; 70/63

(57) ABSTRACT

A steel bar for securing and tracking shipping containers including an elongated body member and a length adjusting member. The bar includes a curved first end and a flange portion at a second end having a plurality of apertures. The length adjusting member includes a body member having a plurality of sidewalls with each sidewall having a slot for insertion therethrough of the body member. A cross bar having an aperture is provided between two of the sidewalls. A front wall can be provided between the same two sidewalls and hides the cross member. In use, the adjusting member is positioned along the body member to a desired position, where the cross bar aperture is aligned with one of the plurality of apertures of the flange portion. A padlock is inserted into the aligned apertures to lock the steel bar in place and prevent movement of the adjustment member. The steel bar and the padlock can be used in a system that uses, as an electronic seals placed on the doors of the containers.

This application claims priority to and the benefit of U.S. Application Ser. No. 60/820,439, filed Jul. 26, 2006, which is incorporated by reference in its entirety.

### 1. FIELD OF THE INVENTION

The present invention relates generally to shipping containers and particularly to a bar and lock assembly for a shipping container.

### 2. SUMMARY OF THE INVENTION

The present invention generally provides a bar, preferably steel, and padlock assembly for securing and tracking shipping containers. The bar includes an elongated body member and a length adjusting member. The bar includes a curved first end. Beginning at approximate to the opposite end of the elongated body member (on the opposite side of the body member with respect to the curved end), a flange portion is disposed and contains a plurality of apertures. Flange portion can be at least substantially perpendicular to the remaining portion of the elongated body member.

The length adjusting member can include a body member having a plurality of sidewalls. The sidewalls can each be provided with slots for receiving the non-curved end of the elongated body member, including the flange portion. The slots can correspond to the shape of the non-curved/second end of the body member. A cross bar or member can be provided between two of the sidewalls. The cross member can be provided with an aperture. A front wall can be provided between the same two sidewalls and hides the cross member from a front view.

In use, the second end of the body member is disposed within the slots and the length adjusting member is positioned along the body member until the desired length of distance between the curved end and the first sidewall achieved (i.e. which is based on the size of the door or container to which steel bar is to be attached). At the desired position, the cross bar aperture can be aligned with one of the plurality of apertures of the flange portion of the body member.

A padlock is inserted into the aligned apertures to lock the steel bar in place and prevent movement of the adjustment member. The steel bar and the padlock can be used in a system that uses, as an electronic seals placed on the doors of the containers. These autonomous devices can have sensors and an internal radio frequency transmitter that allows information to be obtained at a remote monitoring center concerning events such as break-ins, motions, tilting, etc. When an irregularity is detected, security personnel can be dispatch to respond and the irregularity can be registered in the software system.

The steel bar can be an extra-hard steel bar and is preferably composed of about 6 millimeter thick steel plate that allows both container doors to be secured when the locking bar is in place. The steel bar can also serve as support to locate the electronic padlock seal.

### 2. BRIEF DESCRIPTION OF THE DRAWINGS

FIGS. 1-8 illustrate various view of the steel bar in accordance with present invention; and.

FIG. 9 is a perspective view of a padlock that can be used in accordance with the present invention.

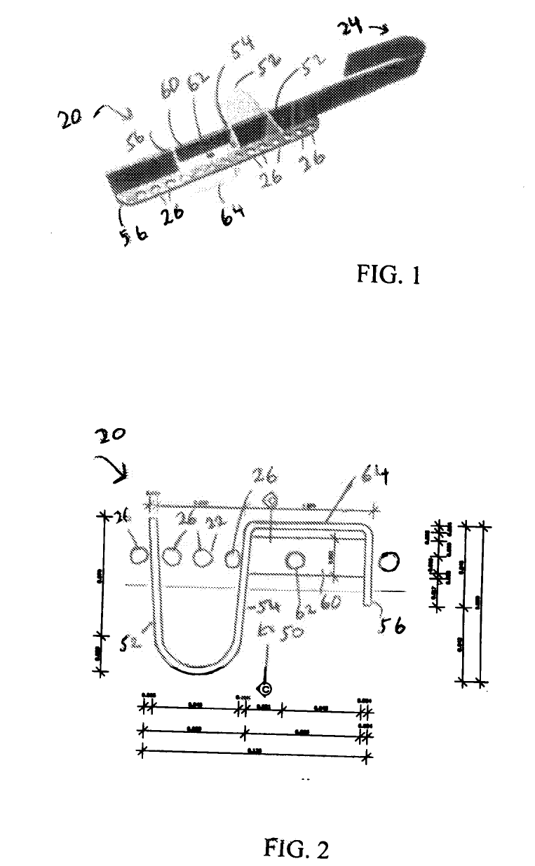

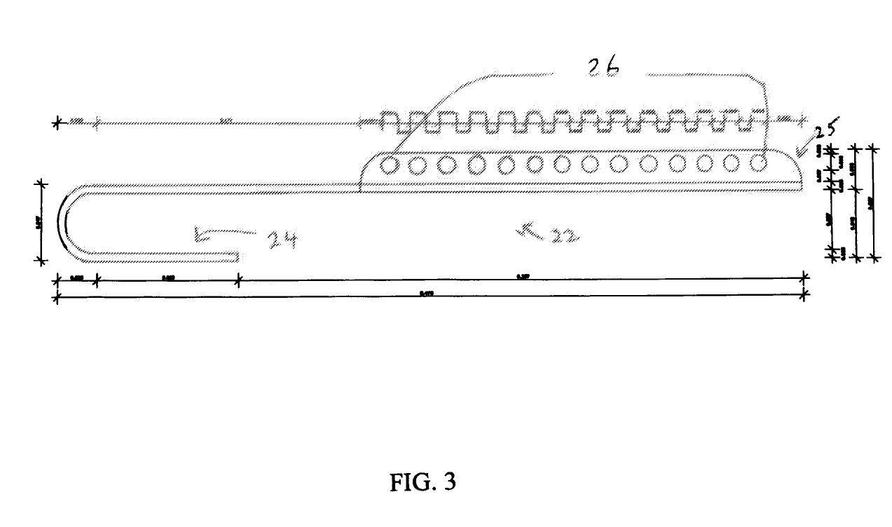

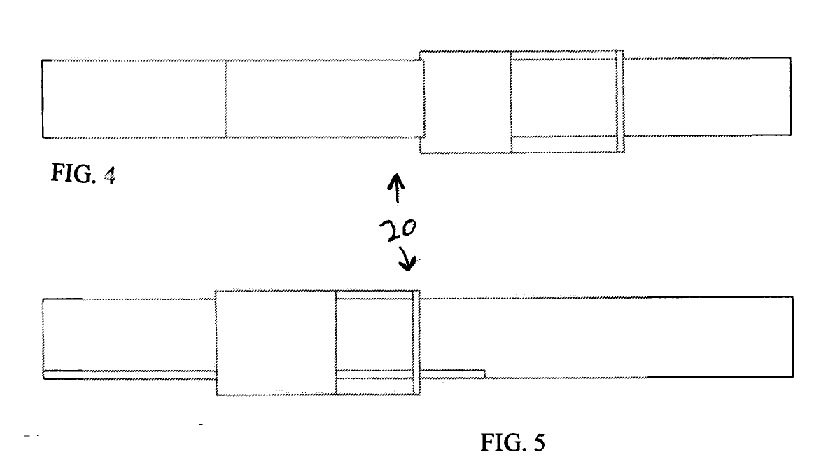

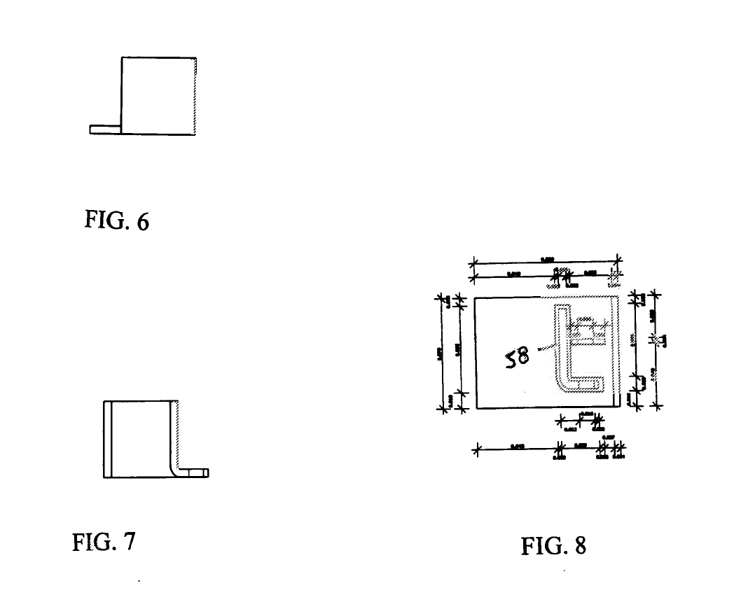

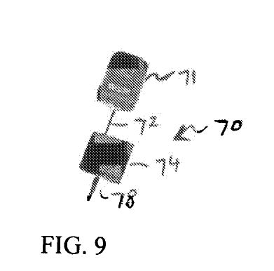

### 3. DETAILED DESCRIPTION OF THE PREFERRED EMBODIMENT

As seen in the Figures a steel bar and padlock assembly for securing and tracking shipping containers in accordance with the present invention is illustrated and generally referred as steel bar 20. Bar 20 includes an elongated body member 22 and a length adjusting member 50. Bar 20 includes a curved first end 24. Beginning at approximate to the opposite end of body member 20 can be provided a flange 25 (on the opposite side of the body member with respect to curved end 24) having a plurality of apertures 26 disposed therein.

Length adjusting member 50 includes a body member 52 having a plurality of sidewalls 52, 54 and 56. Sidewalls 52, 54 and 56 can be provided with slots 58 for receiving the end 25 of body member 22. Slots 58 can correspond to the shape of end 25 of body member 22. A cross bar or member 60 is provided between walls 54 and 56. Cross member 60 is provided with an aperture 62. A front wall 64 is provided between walls 54 and 56 and hides cross member 60 from a front view. For discussion purposes only, sidewalls 52, 54 and 56 can be considered to be at least substantially vertical in position and cross bar 60 can be considered to be at least substantially horizontal in position and also substantially parallel with flange 25 of body member 22.

In use, end 25 is disposed within the slots 58 and member 50 is positioned along body member 22 until the desired length of distance between curved end 24 and sidewall 52 is achieved (i.e. which is based on the size of the door or container to which steel bar is to be attached). At the desired position, aperture 62 is aligned with one of the apertures 26 of body member 22.

A post 72 of a padlock 70 is inserted into the aligned apertures to lock steel bar 20 in place and prevent movement of adjustment member 50. A locking portion 74 is secured to the portion of the post 72 extending through the aligned apertures and can only be unlocked by key 78. Front wall 64 acts as a blocking member for preventing tampering of the post 72/locking portion 74 connection by hiding such portions of padlock behind front wall 64. The electronics/intelligence described in more detail below can be contained with housing 71 connected to post 72.

Steel bar 20 and the padlock can be used in a system that uses, as an electronic seals placed on the doors of the containers. These autonomous devices can have sensors and an internal radio frequency transmitter that allows information to be obtained at a remote monitoring center concerning events such as break-ins, motions, tilting, etc. When an irregularity is detected, security personnel can be dispatch to respond and the irregularity can be registered in the software system.

Steel bar 20 can be an extra-hard steel bar and is preferably composed of about 6 millimeter thick steel plate that allows both container doors to be secured when the locking bar 20 is in place. Steel bar 20 can also serve as support to locate the electronic padlock seal.

The padlock seal can be provided with electronics and:

(1) It has an integrated radio system that allows working in two directions. As a transmitter it can send an alarm to our monitoring center when it detects a violation. As a receptor it receives security information.

(2) It presents three types of sensors that allow receiving information about motion, tilting, and authorized or unauthorized door opening.

(3) It has two internal memories. The first one records data such as the container serial number, name of the fleet, transporter, and more. The second stores events with their dates and times of execution. For example, the activation or deactivation of the seal, movements made by the container, tilting or door opening if they are removed.

(4) It has an exclusive identifier for each seal to avoid cloning.

(5) Its locking system is with a Multi-Lock padlock with a key that cannot be duplicated.

(6) It has an internal clock that allows the recording of all information with dates and times at the moment they occur.

The system can include a microreader which can be a wireless reader/activator that carries out simple operations of verification and activation of the electronic seal. It can report when there have been any violations of the electronic seal, subsequently activating it for another new security process.

The system can also include a wireless portable computer which executes an application that allows recording, reading, or verifying the condition of up to 280 electronic seals at the same time. The wireless or handheld device can downloads the stored information in the seal's memory without deleting it. Subsequently, it can be saved in the computers at the remote monitoring center. Stored information can include the date and time of the electronic seal installation, at the supplier's warehouse, the time elapsed until the arrival, violations, movements in the trip, and all freight details upon the users demand.

The system can also include Global Positioning System SAT-201 having GPS with satellite communication both to receive and transmit information. This can allow monitoring the protected freight with worldwide coverage with no “dark zones” (areas without signal) and in real-time. The software can allow for visualizing, with a geographic map, the route of the freight on the client's computer. It also sends reports about the position of the container every fifteen minutes or other set time interval. If a violation occurs, it transmits an alarm within the quickest time possible.

The monitoring system can also be used for tanker trucks and service stations, with the electro-magnetic seals of the present invention designed to control and block each valve and lid of the tanker, operating in conjunction with level and fluid sensors that allow for the precise measurement of fuel. These devices have a wireless connection with the present invention satellite positioning equipment (GPS), which can be located in the cabin of the truck and which is the means of communication that makes it possible to send a report about the state of the system to the information center, such as, any opening or closing of the seals and also the precise location of the vehicle.

The wireless communication of the present invention system facilitates the installation of the system so that it doesn't need wires and cables between equipment, which prevents the deterioration of the wires and cables or incorrect manipulation of them that can produce electric sparks. The GPS equipment of the present invention can work with the network of inmarsat geostationary satellites which provide worldwide coverage. This maintains permanent communication without zones that don't have signal with the tanker trucks.

The instant invention has been shown and described herein in what is considered to be the most practical and preferred embodiment. While the invention has been described and disclosed in certain terms and has disclosed certain embodiments or modifications, persons skilled in the art, who have acquainted themselves with the invention, will appreciate that it is not necessarily limited by such terms, nor to the specific embodiments and modifications disclosed herein. Thus, a wide variety of alternatives, suggested by the teachings herein, can be practiced without departing from the spirit of the invention, and rights to such alternatives are particularly reserved and considered within the scope of the invention.

What is claimed is:

1. A metal locking assembly for a shipping container, comprising:
an elongated body member having a curved first end and a second end, said body member having a elongated flange portion beginning approximate to said second end, said flange portion having a plurality of apertures;
a length adjusting member having a plurality of sidewalls with each sidewall having a substantially “L” shaped slot extending therethrough for insertion of a portion of said elongated body member including said elongated flange portion therethrough, said length adjusting member having a cross bar extending between two of said plurality of sidewalls and having an aperture therethrough; and
a lock having a post portion;
wherein said length adjusting member is connected to said elongated body member such that it is movable along said elongated body member in order to align position said cross bar aperture with one of the elongated flange apertures for receipt of a portion of said lock.

2. The metal locking assembly of claim 1 wherein said length adjusting member having a front wall extending between the same two side walls that said cross bar extends between and helps to prevent tampering of said lock when in use.

3. The metal locking assembly of claim 1 wherein said elongated body member is constructed from steel.

4. The metal locking assembly of claim 1 wherein said lock is a padlock.

5. The metal locking assembly of claim 1 having one or more sensors disposed on said body member or said length adjusting member for remotely monitoring said metal locking assembly.

6. The metal locking assembly of claim 1 wherein said elongated body member is constructed from at least about 6 millimeter thick steel.

7. The metal locking assembly of claim 1 wherein said lock is an electronic padlock.
